(19) United States
(12) Patent Application Publication
(10) Pub. No.: US 2009/0300214 A1
(43) Pub. Date: Dec. 3, 2009

(54) Communication Device and Communication Method

(75) Inventor: Ryo Ogata, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/268,999

(22) Filed: Nov. 11, 2008

(30) Foreign Application Priority Data
May 30, 2008 (JP) 2008-143315

(51) Int. Cl. G06F 15/173

(52) U.S. Cl. 709/238

(57) ABSTRACT

According to one embodiment, a communication device, which receives via a router content data distributed through a network, includes a communicating module. The communicating module includes a notifying module and a time calculator. The notifying module transmits a reception-start notification and a reception-end notification for content data to the router through the network. The time calculator calculates first time to transmit the reception-start notification such that the first time differs from the time distribution of the content data starts. The time calculator calculates second time to transmit the reception-end notification such that the second time differs from the time the distribution of the content data ends.

### CROSS-REFERENCE TO RELATED APPLICATIONS

This application is based upon and claims the benefit of priority from Japanese Patent Application No. 2008-143315, filed May 30, 2008, the entire contents of which are incorporated herein by reference.

### BACKGROUND

1. Field

One embodiment of the invention relates to a communication device and a communication method, and, more particularly, to a communication device and a communication method for receiving content data distributed through a network to a plurality of communication devices.

2. Description of the Related Art

With Internet protocol (IP) televisions and the like, the same content data is multicast to a plurality of receiver terminals specified in a network. For example, Japanese Patent Application Publication (KOKAI) No. 2003-259328 discloses a content distributor which distributes content to content receiver terminals. The content distributor uses a plurality of channels for multicast of the same content, and distributes the content to the content receiver terminals at different distribution start timing for each channel. With this, an increase in load on the network is suppressed even if the number of content receiver terminals increases.

Terminals such as IP televisions, which receive content data distributed via multicast, transmit a message according to a multicast control protocol to a router when starting and stopping receipt of the content data to notify the router of reception start and reception end. Examples of the multicast control protocol include Internet group management protocol (IGMP) and multicast listener discovery (MLD).

The IGMP is used for multicasting in IPv4 environment. In the IGMP, when multicast reception starts, a report message is transmitted to the router as a reception-start notification and a done message is transmitted as a reception-end notification. The MLD is used for multicasting in IPv6 environment. In the MLD, a report message is transmitted at the time multicast reception starts and ends.

If reception-start and reception-end notifications are simultaneously transmitted from a plurality of terminals to a single router, load on the router temporarily increases. As a result, the messages may not be processed normally, or a failure may occur in a network. These are likely to occur, for example, when the time to start and stop content data distribution are fixed, such as when data for software update is distributed via multicast or when a scheduled content is viewed and recorded.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of a communication system that includes an communication terminal according to an embodiment of the invention;

FIG. 2 is an exemplary block diagram of the communication terminal in the embodiment;

FIG. 3 is an exemplary table of unique values stored in the communication terminal in the embodiment;

FIG. 4 is an exemplary schematic diagram illustrating where all communication terminals connected to a network simultaneously transmit a reception-start notification in the embodiment;

FIG. 5 is an exemplary schematic diagram illustrating where the communication terminals connected to the network transmit the reception-start notification at different time points in the embodiment;

FIG. 6 is an exemplary schematic diagram illustrating where a reception-start notification and a reception-end notification are transmitted for receiving content data distributed once during a period from start to end of content distribution in the embodiment;

FIG. 7 is an exemplary schematic diagram illustrating where the reception-start notification and the reception-end notification are transmitted for sequentially receiving two sets of content data distributed once during a period from start to end of content distribution in the embodiment; and

FIG. 8 is an exemplary schematic diagram illustrating where the reception-start notification and the reception-end notification are transmitted for receiving content data distributed a plurality of times during a period from start to end of content distribution in the embodiment.

### DETAILED DESCRIPTION

Various embodiments according to the invention will be described hereinafter with reference to the accompanying drawings. In general, according to one embodiment of the invention, a communication device, which receives via a router content data distributed to a plurality of communication devices through a network, includes a communicating module configured to perform communication through the network. The communicating module includes a notifying module configured to transmit a reception-start notification and a reception-end notification for content data to the router through the network, and a time calculator configured to calculate time for the notifying module to transmit the reception-start notification and the reception-end notification. The time calculator calculates first time to transmit the reception-start notification such that the first time differs from the time distribution of the content data starts through the network. The time calculator calculates second time to transmit the reception-end notification such that the second time differs from the time the distribution of the content data ends.

According to another embodiment of the invention, a communication method for receiving via a router content data distributed to a plurality of communication devices through a network, includes: transmitting a reception-start notification and a reception-end notification for content data to the router through the network; calculating first time to transmit the reception-start notification such that the first time differs from the time distribution of the content data starts through the network; and calculating second time to transmit the reception-end notification such that the second time differs from the time the distribution of the content data ends.

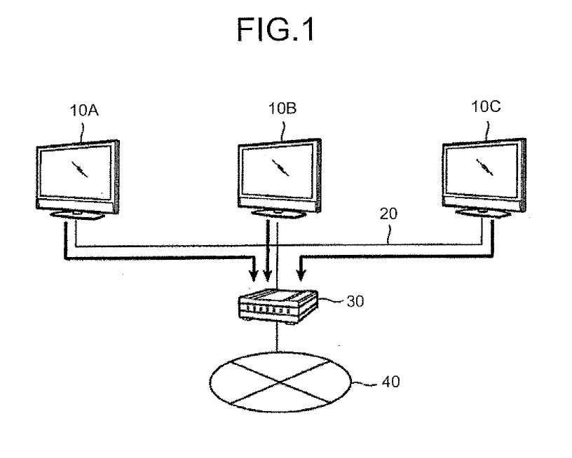

FIG. 1 is a schematic diagram of a communication system including a communication terminal according to an embodiment of the invention. As illustrated in FIG. 1, in the communication system of the embodiment, communication terminals 10A to 10C are mutually connected through a network 20. The network 20 is connected to a multicast network 40 via a router 30 so that the communication terminals 10A to 10C can receive content data from the multicast network 40.

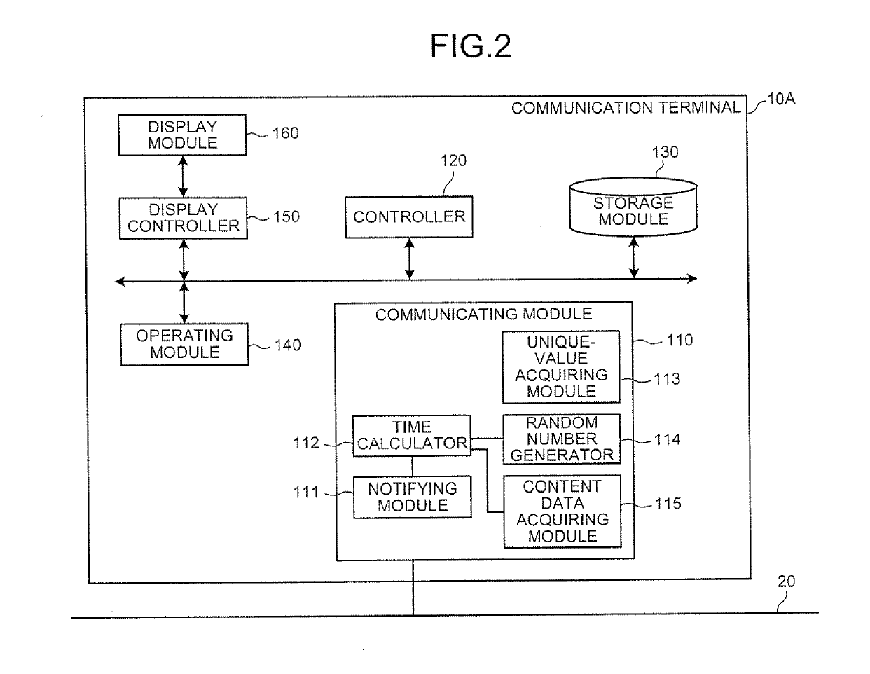

The communication terminals 10A to 10C are of like configuration and thus but one of them, for example, the communication terminal 10A will be described in detail. FIG. 2 is a block diagram of the communication terminal 10A. As illustrated in FIG. 2, the communication terminal 10A includes a communicating module 110, a controller 120, a storage module 130, an operating module 140, a display controller 150, and a display module 160, which are connected via a bus.

The communicating module 110 performs communication via the network 20 using Internet protocol (IP). The communicating module 110 includes a notifying module 111, a time calculator 112, a unique-value acquiring module 113, a random number generator 114, and a content data acquiring module 115.

The notifying module 111 transmits a reception-start notification and a reception-end notification, indicating the start and end of content data reception, to the router 30 via the network 20. If the multicast network 40 uses IGMP as a multicast control protocol, the notifying module 111 transmits a report message to the router 30 as the reception-start notification and transmits a done message thereto as the reception-end notification. If the multicast network 40 uses MLD as a multicast control protocol, the notifying module 111 transmits a report message to the router 30 at the time content data reception starts and ends.

The time calculator 112 calculates the time for the notifying module 111 to transmit the reception-start notification and the reception-end notification based on information from the unique-value acquiring module 113, the random number generator 114, and the content data acquiring module 115. The calculation, by the time calculator 112, of the time to transmit the reception-start notification and the reception-end notification will be described later.

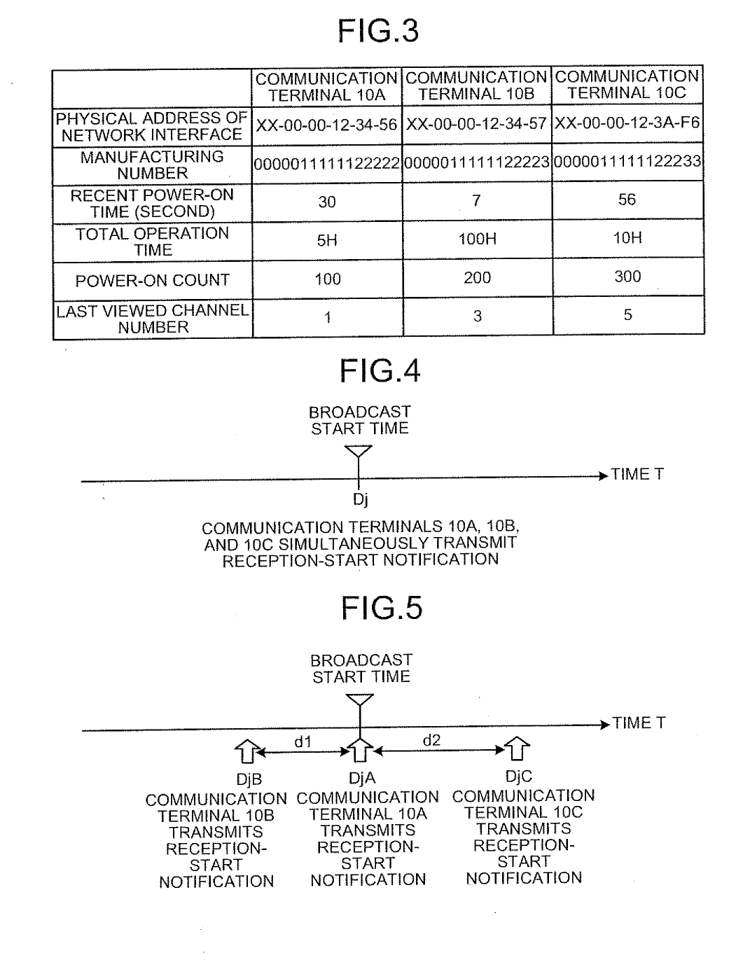

The unique-value acquiring module 113 acquires a unique value unique to the communication terminal 10A. The time calculator 112 calculates the time to transmit the reception-start notification and the reception-end notification based on the unique value. As illustrated in FIG. 3, examples of the unique value for the communication terminal include physical address of network interface, manufacturing number, recent power-on time (the most recent time the power is turned on), total operation time, power-on count (the number of times the power is turned on) and last viewed channel number. The unique-value acquiring module 113 acquires such unique values from the storage module 130.

The random number generator 114 generates a random number based on which the time calculator 112 calculates the time to transmit the reception-start notification and the reception-end notification. The content data acquiring module 115 acquires, from the network 20, the storage module 130, etc., information such as the number of a channel for distribution of content data received by the communication terminal 10A, and the time content data distribution starts and ends (distribution start time and distribution end time).

The controller 120 can be a central processing unit (CPU) that executes predetermined control programs and controls the overall operation of the communication terminal 10A.

The storage module 130 can be a read only memory (ROM) or a hard disk drive (HDD) that stores the predetermined control programs. The storage module 130 also stores information on the communication terminal 10A, such as physical address of network interface, manufacturing number, recent power-on time, total operation time, power-on count, and last viewed channel number, as unique values unique to the communication terminal 10A. The time calculator 112 calculates the time to transmit the reception-start notification and the reception-end notification based on the unique values. As illustrated in FIG. 3, the communication terminals 10B and 10C, which are connected to the network 20, also store their unique values. Further, the storage module 130 stores information including content data received by the communication terminal 10A, the number of a channel for distribution of the content data, and the distribution start time and the distribution end time of the content data.

The operating module 140 can be a button or a remote control signal light receiver, and is an interface that is used by a user to provide input. The display controller 150 controls the display module 160 to display an image based on content data received by the communicating module 110 under the control of the controller 120. The display module 160 can be formed of a liquid crystal display (LCD), and displays an image based on signals output from the display controller 150.

Described below is the operation of the communication terminals 10A to 10C according to the embodiment. As illustrated in FIG. 4, if the communication terminals 10A to 10C simultaneously transmit a reception-start notification to the router 30 at time T=Dj that is broadcast start time of a program related to multicast content data, load on the router 30 temporarily increases. In this case, the message may not be processed normally, or a failure may occur in the network 20. According to the embodiment, the notifying module 111 of each of the communication terminals 10A to 10C transmits a reception-start notification and a reception-end notification to the router 30 at a different time point, which prevents the occurrence of the events mentioned above.

As illustrated in FIG. 5, for example, the communication terminal 10A transmits a reception-start notification at time T=DjA corresponding to the broadcast start time of the program. The communication terminal 10B transmits a reception-start notification at time T=DjB that precedes the broadcast start time by a time period d1. The communication terminal 10C transmits a reception-start notification at time T=DjC that is delayed from the broadcast start time by a time period d2. In this manner, the communication terminals 10A to 10C transmit their reception-start notifications at different time points to disperse the load on the router 30. The same applies to the reception-end notification.

Specifically, the time calculator 112 of the communication terminal 10A calculates a time period d₀ for calculating T=DjA, i.e., the time to transmit the reception-start notification, based on unique values as illustrated in FIG. 3 acquired by the unique-value acquiring module 113 from the storage module 130 using the equation as follows:

d₀=α₁·A₁+α₂·A₂+α₃·A₃+α₄·A₄+α₅·A₅+α₆·A₆

where A₁ is the physical address of the network interface of the communication terminal 10A (English alphabet is converted to a random number), A₂ is the manufacturing number of the communication terminal 10A, A₃ is the recent power-on time of the communication terminal 10A, A₄ is the total operation time of the communication terminal 10A, A₅ is the power-on count of the communication terminal 10A, A₆ is the last viewed channel number of the communication terminal 10A, and α₁ to α₆ are arbitrary coefficients. The time calculator 112 adds the calculated time period d₀ to the distribution time of the program received from the content data acquiring module 115 to obtain the transmission time T=DjA of the reception-start notification. In the example of FIG. 5, d₀ is 0, and the distribution time of the program is the same as the transmission time DjA of the reception-start notification. Actually, however, in the environment where a plurality of communication terminals (10A to 10C) are connected to the network 20, to prevent the communication terminals from transmitting a reception-start notification or a reception-end notification at the same time, the transmission time of the reception-start notification is set to be different from the time broadcast of the program starts for each of the communication terminals. Further, the transmission time of the reception-end notification is calculated in the same manner.

Alternatively, when transmitting a reception-start notification or a reception-end notification, the time calculator 112 of each of the communication terminals 10A to 10C can calculate the time to transmit the reception-start notification or the reception-end notification based on a random number generated by the random number generator 114.

Thus, the time periods d₀ to d₂ are not fixed for all the communication terminals 10A to 10C, but are calculated based on unique values or a random number for them respectively. With this, the communication terminals 10A to 10C under the same conditions are prevented from simultaneously transmitting their reception-start notifications and reception-end notifications.

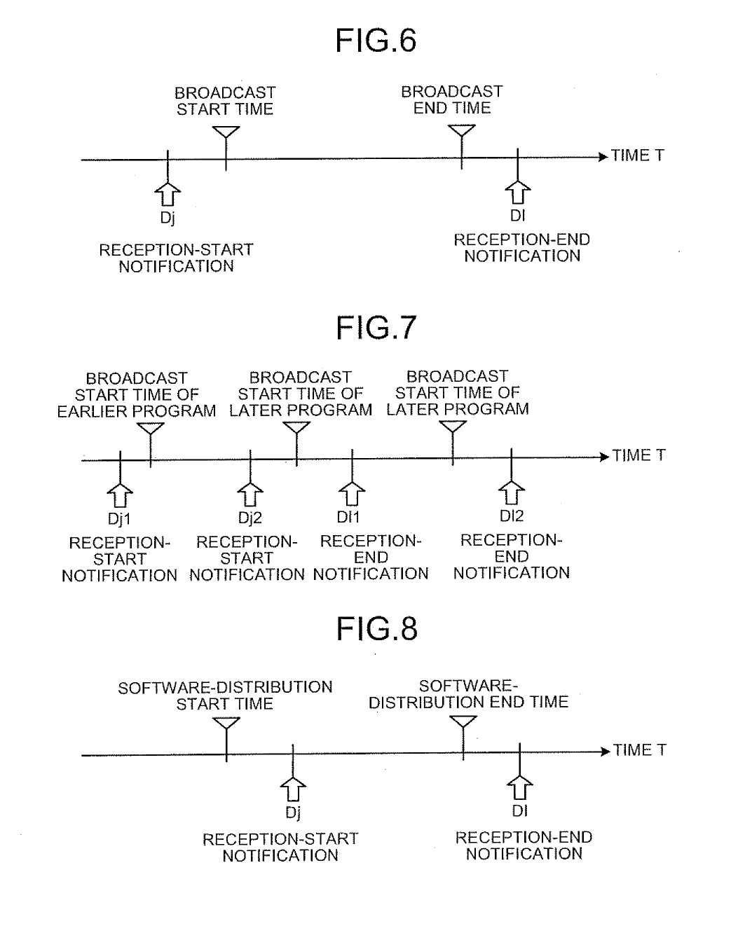

As illustrated in FIG. 6, if the distribution start time and the distribution end time of content data are uniquely determined, i.e., if content data is distributed only once during a period from start to end of content distribution as in the case of a broadcast program, the time to transmit a reception-start notification can be set to time Dj that precedes the broadcast start time of the program and the time to transmit a reception-end notification can be set to time Dl that is delayed from the broadcast end time of the program. The time calculator 112 receives, from the content data acquiring module 115, information indicating that the content data is distributed only once during a period from start to end of content distribution, and calculates the time to transmit the reception-start notification and the reception-end notification.

FIG. 7 is a schematic diagram illustrating where reception-start notifications and reception-end notifications are transmitted for sequentially receiving two sets of content data distributed once during a period from start to end of content distribution. FIG. 7 illustrates a modification of the example of FIG. 6. As illustrated in FIG. 7, the time calculator 112 can set the time to transmit a reception-start notification for a program that is broadcast earlier to Dl1 that precedes the broadcast start time of the earlier program. The time calculator 112 can set the time to transmit a reception-end notification for the earlier program to Dl1 that is delayed from the broadcast end time of the earlier program. Similarly, the time calculator 112 can set the time to transmit a reception-start notification for a program that is broadcast later to Dj2 that precedes the broadcast start time of the later program. Further, the time calculator 112 can set the time to transmit a reception-end notification for the later program to Dl2 that is delayed from the broadcast end time of the later program.

Thus, even in the case of successively receiving a plurality of sets of content data distributed once during a period from broadcast start time to broadcast end time, the time to transmit reception-start notifications and reception-end notifications can be calculated separately.

FIG. 8 is a schematic diagram illustrating the time to transmit a reception-start notification and a reception-end notification for receiving the same content data distributed a plurality of times during a period from start to end of content distribution as in the case of service information (SI) including program information or update data for updating software. In such a case, the time Dj to transmit the reception-start notification can be set to precede software-distribution start time or to be delayed from the software-distribution start time. Similarly, the time Dl to transmit the reception-end notification can be set to precede software-distribution end time or to be delayed from the software-distribution end time.

However, the time Dj to transmit the reception-start notification and the time Dl to transmit the reception-end notification are set to the time sufficient for receiving the content data once. Specifically, the time Dj to transmit the reception-start notification is set to precede at least the time one distribution of the content data starts. The time Dl to transmit the reception-end notification is set to be delayed from at least the time the one distribution of the content data ends. The time calculator 112 receives, from the content data acquiring module 115, information indicating that the content data is distributed a plurality of times during a period from distribution start time to distribution end time, and calculates the time to transmit the reception-start notification and the reception-end notification.

As described above, according to the embodiment, the time calculator 112 calculates the time to transmit a reception-start notification for content data such that the time differs from the time distribution of the content data starts through the multicast network 40. Further, the time calculator 112 calculates the time to transmit a reception-end notification for the content data such that the time differs from the time distribution of the content data ends. Thus, it is possible to reduce load due to reception-start notifications and reception-end notifications simultaneously transmitted from a plurality of communication devices to a router for receipt of content data distributed via multicast.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A communication device that receives via a router content data distributed to a plurality of communication devices through a network, the communication device comprising:
a communicating module configured to perform communication through the network, the communicating module including
a notifying module configured to transmit a reception-start notification and a reception-end notification for content data to the router through the network, and
a time calculator configured to calculate time for the notifying module to transmit the reception-start notification and the reception-end notification, wherein
the time calculator calculates first time to transmit the reception-start notification such that the first time differs from time distribution of the content data starts through the network, and
the time calculator calculates second time to transmit the reception-end notification such that the second time differs from time the distribution of the content data ends.

2. The communication device according to claim 1, further comprising a unique-value acquiring module configured to acquire a unique value unique to the communication device, wherein
the time calculator calculates based on the unique value acquired by the unique-value acquiring module, the time to transmit the reception-start notification and the reception-end notification.

3. The communication device according to claim 2, wherein the unique value is at least one of address of the communication device in the network, manufacturing number of the communication device, recent power-on time of the communication device, power-on count of the communication device, total operation time of the communication device, and channel number of content data most recently received by the communication device.

4. The communication device according to claim 1, further comprising a random number generator configured to generate a random number, wherein
the time calculator calculates, based on the random number generated by the random number generator, the time to transmit the reception-start notification and the reception-end notification.

5. The communication device according to claim 1, wherein, when the content data is distributed once during a period from start to end of the distribution of the content data, the time calculator calculates the first time and the second time such that
the first time precedes the time the distribution of the content data starts, and
the second time is delayed from the time the distribution of the content data ends.

6. The communication device according to claim 5, wherein, when distribution of second content data starts subsequent to end of distribution of first content data, the time calculator calculates time to transmit a reception-start notification and a reception-end notification for each of the first content data and the second content data such that
the time to transmit the reception-end notification for the first content data precedes time the distribution of the first content data starts,
the time to transmit the reception-end notification for the first content data is delayed from time the distribution of the first content data ends,
the time to transmit the reception-end notification for the second content data precedes time the distribution of the second content data starts, and
the time to transmit the reception-end notification for the second content data is delayed from time the distribution of the second content data ends.

7. The communication device according to claim 1, wherein, when the content data is distributed a plurality of times during a period from start to end of the distribution of the content data, the time calculator calculates the first time and the second time such that
the first time precedes or is delayed from the time the distribution of the content data starts, and
the second time precedes or is delayed from the time the distribution of the content data ends.

8. The communication device according to claim 7, wherein the time calculator calculates the first time and the second time such that
the first time precedes time one distribution of the content data starts, and
the second time is delayed from time the one distribution of the content data ends.

9. The communication device according to claim 1, further comprising a display module configured to display content related to the content data that the communicating module receives by communication through the network.

10. A communication method for receiving via a router content data distributed to a plurality of communication devices through a network, the communication method comprising:
transmitting a reception-start notification and a reception-end notification for content data to the router through the network;
calculating first time to transmit the reception-start notification such that the first time differs from time distribution of the content data starts through the network; and
calculating second time to transmit the reception-end notification such that the second time differs from time the distribution of the content data ends.
